(19) United States
(12) Patent Application Publication
(10) Pub. No.: US 2018/0300256 A1
(43) Pub. Date: Oct. 18, 2018

(54) MAINTAINING AGENT INCLUSIVITY WITHIN A DISTRIBUTED MMU

(71) Applicant: International Business Machines Corporation, Armonk, NY (US)

(72) Inventors: BARTHOLOMEW BLANER, SHELBURNE, VT (US); JODY B. JOYNER, AUSTIN, TX (US); RONALD N. KALLA, ROUND ROCK, TX (US); JON K. KRIEGEL, ROCHESTER, MN (US); CHARLES D. WAIT, BYRON, MN (US)

(21) Appl. No.: 15/818,050

(22) Filed: Nov. 20, 2017

Related U.S. Application Data
(63) Continuation of application No. 15/487,048, filed on Apr. 13, 2017.

(51) Int. Cl. G06F 12/1027; G06F 12/1009

(52) U.S. Cl. CPC G06F 12/1027; G06F 2212/68; G06F 2212/154; G06F 12/1009

(57) ABSTRACT

Maintaining agent inclusivity within a distributed memory management unit (MMU) including receiving, from an agent, a translation checkout request comprising an effective address (EA) and an effective address to real address table (ERAT) index; translating the EA to a real address (RA) using an entry in a translation lookaside buffer (TLB) within the MMU, wherein the TLB within the MMU comprises an RA for each EA in the ERAT within the agent; flagging the entry in the TLB as in use by the agent, wherein the entry in the TLB comprises a TLB index; storing the EA index and the TLB index in an in-use scoreboard (IUSB), wherein the IUSB maps TLB indexes identifying entries in the TLB within the MMU to ERAT indexes identifying entries in the ERAT within the agent; and sending, to the agent, a translation checkout response comprising the RA.

### CROSS-REFERENCE TO RELATED APPLICATION

This application is a continuation application of U.S. patent application Ser. No. 15/487,048, filed Apr. 13, 2017.

### BACKGROUND

### Field of the Invention

The field of the invention is data processing, or, more specifically, methods, apparatus, and products for maintaining agent inclusivity within a distributed memory management unit (MMU).

### Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One area of computer system technology that has advanced is computer processors. As the number of computer systems in data centers and the number of mobile computing devices has increased, the need for more efficient computer processors has also increased. Speed of operation and power consumption are just two areas of computer processor technology that affect efficiency of computer processors.

### SUMMARY

Methods and apparatus for maintaining agent inclusivity within a distributed memory management unit (MMU). Maintaining agent inclusivity within a distributed MMU includes receiving, from an agent, a translation checkout request comprising an effective address (EA) and an effective address to real address table (ERAT) index, wherein the agent comprises an ERAT, and wherein the EA index identifies an entry in the ERAT within the agent; translating the EA to a real address (RA) using an entry in a translation lookaside buffer (TLB) within the MMU, wherein the TLB within the MMU comprises an RA for each EA in the ERAT within the agent; flagging the entry in the TLB as in use by the agent, wherein the entry in the TLB comprises a TLB index, and wherein the TLB index identifies the entry in the TLB; storing the EA index and the TLB index in an in-use scoreboard (IUSB), wherein the IUSB maps TLB indexes identifying entries in the TLB within the MMU to ERAT indexes identifying entries in the ERAT within the agent; and sending, to the agent, a translation checkout response comprising the RA.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth an example system configured for maintaining agent inclusivity within a distributed memory management unit (MMU) according to embodiments of the present invention.

FIG. 2 sets forth an example processor configured for maintaining agent inclusivity within a distributed MMU according to embodiments of the present invention.

FIG. 3 sets forth a flow chart illustrating an exemplary method for maintaining agent inclusivity within a distributed MMU according to embodiments of the present invention.

FIG. 4 sets forth a flow chart illustrating an exemplary method for maintaining agent inclusivity within a distributed MMU according to embodiments of the present invention.

FIG. 5 sets forth a flow chart illustrating an exemplary method for maintaining agent inclusivity within a distributed MMU according to embodiments of the present invention.

FIG. 6 sets forth a flow chart illustrating an exemplary method for maintaining agent inclusivity within a distributed MMU according to embodiments of the present invention.

### DETAILED DESCRIPTION

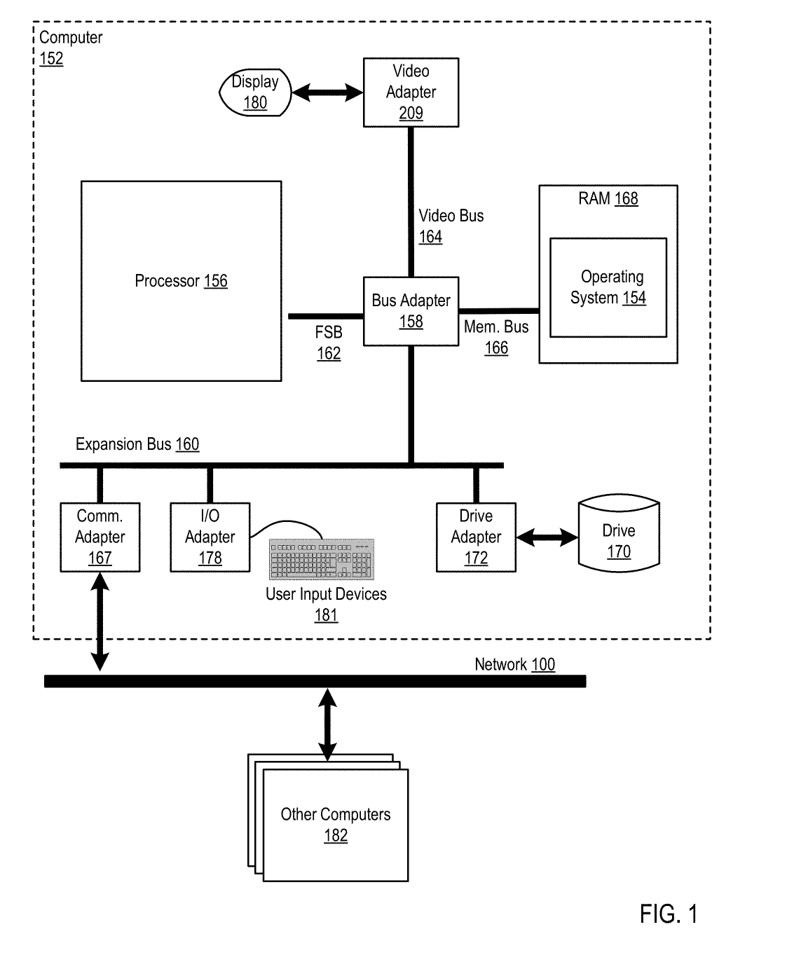

Exemplary methods, apparatus, and products for maintaining agent inclusivity within a distributed memory management unit (MMU) in accordance with the present invention are described with reference to the accompanying drawings, beginning with FIG. 1. FIG. 1 sets forth a network diagram of a system configured for maintaining agent inclusivity within a distributed MMU according to embodiments of the present invention. The system of FIG. 1 includes an example of automated computing machinery in the form of a computer (152).

The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

The example computer processor (156) of FIG. 1 may be implemented as a multi-slice processor. The term ‘multi-slice’ as used in this specification refers to a processor having a plurality of similar or identical sets of components, where each set may operate independently of all the other sets or in concert with the one or more of the other sets.

Although the processor (156) in the example of FIG. 1 is shown to be coupled to RAM (168) through a front side bus (162), a bus adapter (158) and a high speed memory bus (166), readers of skill in the art will recognize that such configuration is only an example implementation. In fact, the processor (156) may be coupled to other components of a computer system in a variety of configurations. For example, the processor (156) in some embodiments may include a memory controller configured for direct coupling to a memory bus (166). In some embodiments, the processor (156) may support direct peripheral connections, such as PCIe connections and the like.

Stored in RAM (168) in the example computer (152) is an operating system (154). Operating systems useful in computers configured for operation of a processor according to embodiments of the present invention include UNIX™, Linux™, Microsoft Windows™, AIX™, IBM's z/OS™, and others as will occur to those of skill in the art. The operating system (154) and data processing application (102) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers configured for operation of a processor according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for operation of a processor according to embodiments of the present invention include modems for wired dial-up communications, Ethernet (IEEE 802.3) adapters for wired data communications, and 802.11 adapters for wireless data communications.

The arrangement of computers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

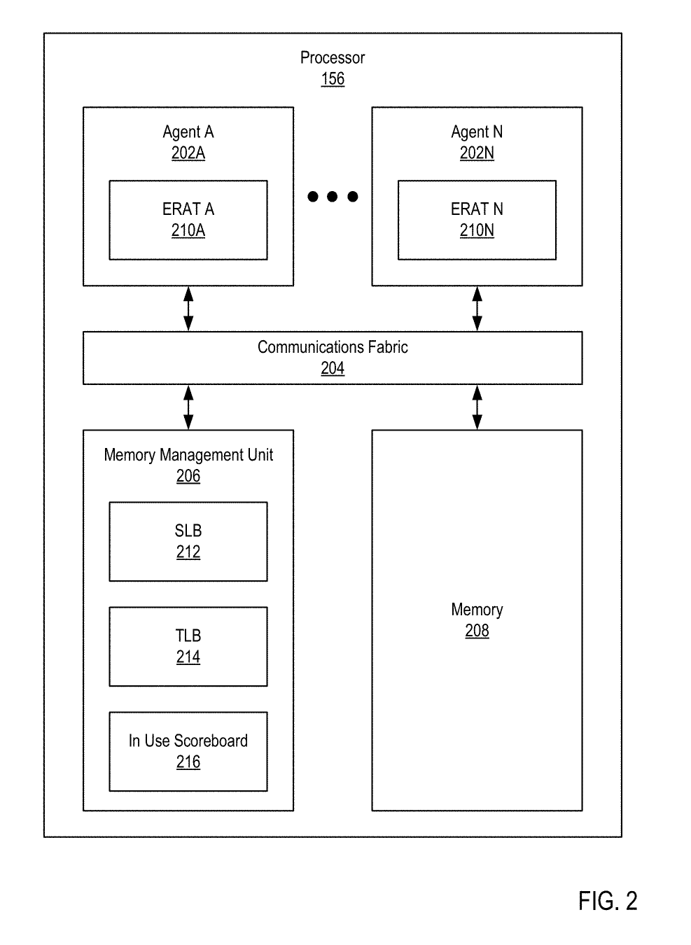

For further explanation, FIG. 2 sets forth an example block diagram of a processor configured for maintaining agent inclusivity within a distributed MMU according to embodiments of the present invention. As shown in FIG. 2, the processor (156) includes multiple agents (agent A (202A), agent N (202N)), a memory management unit (MMU) (206), and memory (208) each coupled to a communications fabric (204) used to transmit messages between the units on the processor (156). Each agent (agent A (202A), agent N (202N)) includes an effective to real address table (ERAT) (ERAT A (210A), ERAT N (210N)), and the MMU (206) includes a segment lookaside buffer (SLB) (212), a translation lookaside buffer (214), and an in use scoreboard (IUSB) (216). Each unit (agent A (202A), agent N (202N), MMU (206), memory (208), and communications fabric (204)) may be implemented on the same semiconducting die or on interconnected dies.

Each agent (agent A (202A), agent N (202N)) is a unit configured to provide an interface between external processing elements and the elements within the processor (156), including providing access to locations in the memory (208). Example of agents include coherent accelerator processor interfaces, graphic acceleration interfaces, cryptographic interfaces, and streaming interfaces.

Each agent maintains an ERAT (ERAT A (210A), ERAT N (210N)) to cache previously received EA to RA translations. The EA is an address used by elements and processes in the computing system to refer to memory locations. However, the EA must be translated into a RA in order to access the requested data. RAs may be referred to as physical addresses.

The ERAT (ERAT A (210A), ERAT N (210N)) stores each EA to RA translation in an ERAT entry (also referred to as a member). Each ERAT entry is associated with an ERAT index, which identifies the ERAT entry within the ERAT. For example, an ERAT index of 4 may refer to the forth (or fifth) entry in the ERAT. A variety of indexing schemes may be used for ERAT indexes.

The MMU (206) is a unit on the processor (156) that translates EAs (or virtual addresses) into RAs (i.e., physical addresses). The MMU (206) performs table walks or other procedures to obtain a translation for a given EA, and stores previous translations in lookaside buffers. The MMU (206) may maintain agent inclusivity, in that each translation cached on the ERATs of some or all of the agents (agent A (202A), agent N (202N)) is also stored within the lookaside buffers on the MMU (206). When an entry is removed from an ERAT on one of the agents, the corresponding entry is also removed from the TLB (214) and, if applicable, the SLB (212). Similarly, an entry removed from the TLB (214) or, if applicable, the SLB (212), causes the removal of corresponding ERAT entries from the ERATs on the agents (agent A (202A), agent N (202N)).

The SLB (212) is a cache of effective segment identifiers (ESID) mapped to virtual segment identifiers (VSID) stored in SLB entries. In hash page table translations, a portion of the EA, referred to as the ESID, is used to obtain a VSID, and a combination of the EA and VSID are used to determine a virtual address. Each SLB entry is associated with an SLB index, which identifies the SLB entry within the SLB. For example, an SLB index of 4 may refer to the forth (or fifth) entry in the SLB. A variety of indexing schemes may be used for SLB indexes.

The TLB (214) is a cache of virtual address mapped to real address stored in TLB entries. Each TLB entry is associated with a TLB index, which identifies the TLB entry within the TLB. For example, an TLB index of 4 may refer to the forth (or fifth) entry in the TLB. A variety of indexing schemes may be used for TLB indexes. Some translations may utilize the TLB (214) without utilizing an SLB (212). For example, a radix translation may use two entries in the TLB (214) (e.g., a guest and host) instead of utilizing an SLB (212).

Each entry in the SLB (212) and the TLB (214) may be associated with a set of agent flags. Each agent flag indicates whether a specific agent is currently storing, in that agent's ERAT, an ERAT entry that corresponds to the SLB or TLB entry. Specifically, if an agent flag for a TLB entry is high or up, the ERAT for the associated agent currently includes a EA to RA translation that utilized that TLB entry. Each TLB entry may have an agent flag for each agent with an inclusive ERAT.

The IUSB (216) is a data structure that stores ERAT indexes mapped to TLB indexes and, if applicable, SLB indexes. The IUSB (216) maps TLB indexes and SLB indexes to ERAT indexes that identify entries in the agent ERATs. The IUSB (216) tracks which entries in the SLB and the TLB store translations that have been utilized to generate translations currently stored in agent ERATs. Specifically, The IUSB (216) indicates, for a given ERAT index, which TLB and SLB entries (identified by TLB indexes and SLB indexes) were used to generate the translation stored in the ERAT entry identified by the ERAT index.

The memory (208) is memory within the processor (156) utilized by the agents (agent A (202A), agent N (202N)) and other units (such as processing cores) on the processor (156). The memory (208) may be an embedded dynamic random access memory (eDRAM). The memory (208) may receive information and messages from the MMU (206), including table walk data requests and page table entry updates.

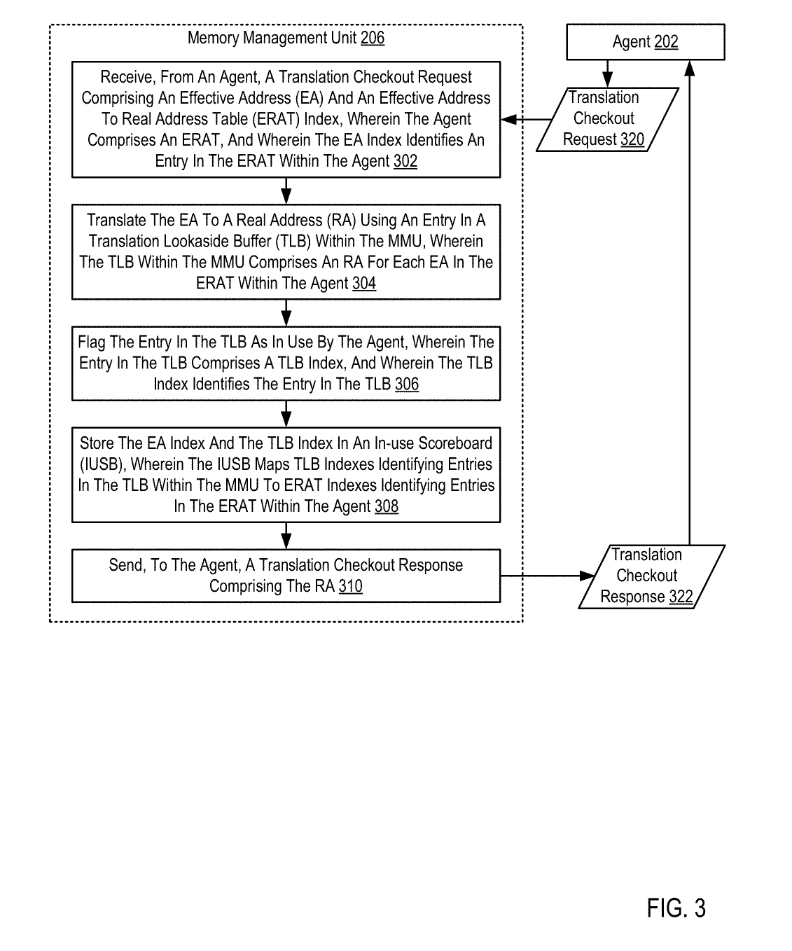

For further explanation, FIG. 3 sets forth a flow chart illustrating an exemplary method for maintaining agent inclusivity within a distributed MMU according to embodiments of the present invention that includes receiving (302), from an agent (202), a translation checkout request (320) comprising an effective address (EA) and an effective address to real address table (ERAT) index, wherein the agent comprises an ERAT, and wherein the EA index identifies an entry in the ERAT within the agent (202). Receiving (302), from an agent (202), a translation checkout request (320) comprising an effective address (EA) and an effective address to real address table (ERAT) index, wherein the agent comprises an ERAT, and wherein the EA index identifies an entry in the ERAT within the agent (202) may be carried out by an agent (202) attempting to retrieve an RA for an EA from the agent's ERAT. The agent (202) may encounter an ERAT miss, meaning that the ERAT does not currently contain a translation for the EA. In response, the agent (202) may send the translation checkout request (320) to the MMU (206). The translation checkout request (320) may include the EA and an ERAT index for an ERAT entry at which the EA to RA translation is to be stored.

The translation checkout request (320) may include information in addition to the ERAT index and EA. The translation checkout request (320) may indicate whether the agent (202) intends to read or write data at the memory location identified by the EA. The translation checkout request (320) may also include an identifier of the agent (202) sending the request.

The method of FIG. 3 also includes translating (304) the EA to a real address (RA) using an entry in a translation lookaside buffer (TLB) within the MMU (206), wherein the TLB within the MMU (206) comprises an RA for each EA in the ERAT within the agent (202). Translating (304) the EA to a real address (RA) using an entry in a translation lookaside buffer (TLB) within the MMU (206), wherein the TLB within the MMU (206) comprises an RA for each EA in the ERAT within the agent (202) may be carried out by using the EA to lookup the entry in the TLB that includes the RA translation of the EA. The EA may first be used with an intermediary lookaside buffer, such as a SLB, to generate an intermediary translation, such as a virtual address. The intermediary translation may then be used as a key into the TLB to obtain the RA.

During the translation of the EA to RA, a TLB or intermediary lookaside buffer miss may occur. Specifically, the MMU may determine that there is no currently cached translation for the EA received in the translation checkout request. Upon encountering a TLB miss, a table walk may be performed in order to generate an RA translation from the EA. Once the table walk is complete, the RA translation may then be stored in a TLB entry mapped to the EA or intermediary translation (such as a virtual address).

The method of FIG. 3 also includes flagging (306) the entry in the TLB as in use by the agent (202), wherein the entry in the TLB comprises a TLB index, and wherein the TLB index identifies the entry in the TLB. Flagging (306) the entry in the TLB as in use by the agent (202), wherein the entry in the TLB comprises a TLB index, and wherein the TLB index identifies the entry in the TLB may be carried out by setting the agent flag for the TLB entry to high or up. Each TLB entry may have an agent flag for each agent for which agent inclusivity is maintained. The agent flag may be stored in the TLB entry or in a separate data structure with entries corresponding to the TLB entries.

The method of FIG. 3 also includes storing (308) the EA index and the TLB index in an in-use scoreboard (IUSB), wherein the IUSB maps TLB indexes identifying entries in the TLB within the MMU (206) to ERAT indexes identifying entries in the ERAT within the agent (202). Storing (308) the EA index and the TLB index in an in-use scoreboard (IUSB), wherein the IUSB maps TLB indexes identifying entries in the TLB within the MMU (206) to ERAT indexes identifying entries in the ERAT within the agent (202) may be carried out by creating a new entry in the IUSB and storing the ERAT index and TLB index in the new IUSB entry.

The method of FIG. 3 also includes sending (310), to the agent (202), a translation checkout response (322) comprising the RA. Sending (310), to the agent (202), a translation checkout response (322) comprising the RA may be carried out by placing the translation checkout response (322) on the communications fabric addressed to the agent (202).

The translation checkout response (322) may include information in addition to the RA. The translation checkout response (322) may include an indication of whether the agent (202) has permission to write data to the memory location identified by the RA. Specifically, if the translation checkout request (320) indicated that the agent (202) intended to read from the memory location identified by the EA, the translation checkout response (322) may indicate that the agent (202) may write to the memory location identified by the RA if necessary at a later time. The translation checkout response (322) may include a page size of the memory page at the memory location identified by the EA.

For example, the MMU (206) may receive a translation checkout request (320) from a graphics acceleration agent (202). The translation checkout request (320) may include an EA of “0600” and an ERAT index of “8”. The MMU (206) may then search the TLB for a TLB entry that has an RA translation for the EA “0600”. Assume that a TLB entry with a TLB index of “BB” is found. The MMU (206) may then translate, using the TLB entry, the EA of “0600” into a RA of “0x0883”. The MMU (206) then flags the TLB entry by setting an agent flag for the graphics acceleration agent (202) to high in the TLB entry. Next, the MMU (206) generates a new entry in the IUSB for the ERAT index of “8” and stores the TLB index of “BB” with the ERAT index. Finally, the MMU (206) generates a translation checkout response (322) including the RA of “0x0883” and sends the translation checkout response (322) to the graphics acceleration agent (202).

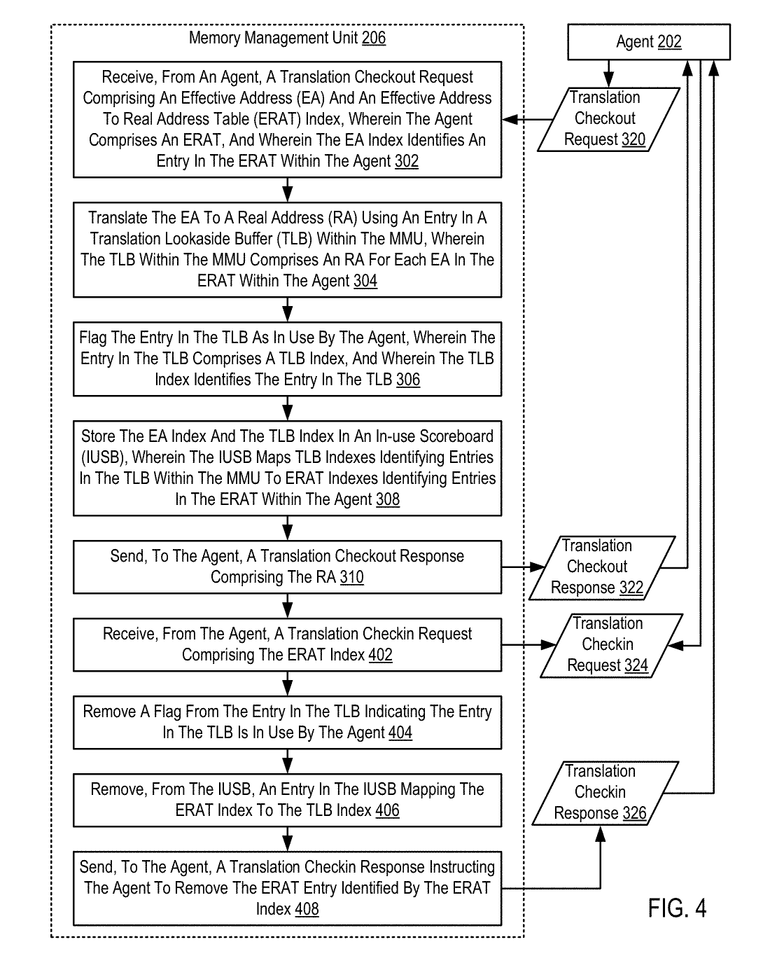

For further explanation, FIG. 4 sets forth a flow chart illustrating a further exemplary method for maintaining agent inclusivity within a distributed MMU according to embodiments of the present invention that includes receiving (302), from an agent (202), a translation checkout request (320) comprising an effective address (EA) and an effective address to real address table (ERAT) index, wherein the agent comprises an ERAT, and wherein the EA index identifies an entry in the ERAT within the agent (202); translating (304) the EA to a real address (RA) using an entry in a translation lookaside buffer (TLB) within the MMU (206), wherein the TLB within the MMU (206) comprises an RA for each EA in the ERAT within the agent (202); flagging (306) the entry in the TLB as in use by the agent (202), wherein the entry in the TLB comprises a TLB index, and wherein the TLB index identifies the entry in the TLB; storing (308) the EA index and the TLB index in an in-use scoreboard (IUSB), wherein the IUSB maps TLB indexes identifying entries in the TLB within the MMU (206) to ERAT indexes identifying entries in the ERAT within the agent (202); and sending (310), to the agent (202), a translation checkout response (322) comprising the RA.

The method of FIG. 4 differs from the method of FIG. 3, however, in that the method of FIG. 4 further includes receiving (402), from the agent (202), a translation checkin request (324) comprising the ERAT index. Receiving (402), from the agent (202), a translation checkin request (324) comprising the ERAT index may be carried out by the agent (202) determining that an ERAT entry should be removed from the ERAT. The entry may be removed based on a determination, by the agent (202), that no space exists in the ERAT for a new ERAT entry, and an older ERAT entry should be removed to make room for the new ERAT entry.

The method of FIG. 4 also includes removing (404) a flag from the entry in the TLB indicating the entry in the TLB is in use by the agent (202). Removing (404) a flag from the entry in the TLB indicating the entry in the TLB is in use by the agent (202) may be carried out by reading the TLB index from an entry in the IUSB corresponding to the ERAT index received in the translation checkin request (324). A TLB entry may be determined from the TLB index from the IUSB. The TLB entry may then be accessed to toggle the agent flag indicating that the translation in the TLB entry is no longer being used by the ERAT for the agent (202). If the TLB entry is then left with no agent flags set (indicating no agent ERATs have entries that utilize the translation stored in the TLB entry), that TLB entry may be subject to removal based on a castout mechanism, such as a least recently used castout mechanism.

The method of FIG. 4 also includes removing (406), from the IUSB, an entry in the IUSB mapping the ERAT index to the TLB index. Removing (406), from the IUSB, an entry in the IUSB mapping the ERAT index to the TLB index may be carried out by matching the received ERAT index to an ERAT index stored in one entry of the IUSB. Once the IUSB entry in the IUSB has been found, that entry is removed from the IUSB.

The method of FIG. 4 also includes sending (408), to the agent (202), a translation checkin response (326) instructing the agent (202) to remove the ERAT entry identified by the ERAT index. Sending (408), to the agent (202), a translation checkin response (326) instructing the agent (202) to remove the ERAT entry identified by the ERAT index may be carried out by generating a translation checkin response (326) that targets the agent (202). The translation checkin response (326) may include a flag that indicates to the agent (202) that the ERAT entry identified by the ERAT index may be removed. The translation checkin response (326) may also include the ERAT index.

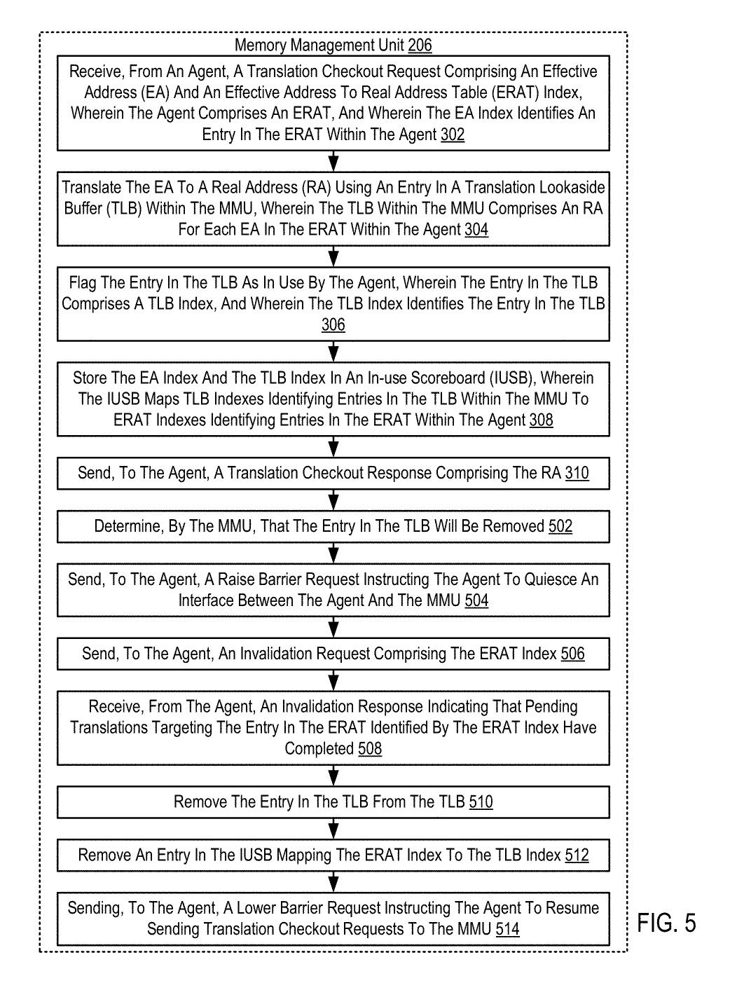

For further explanation, FIG. 5 sets forth a flow chart illustrating a further exemplary method for maintaining agent inclusivity within a distributed MMU according to embodiments of the present invention that includes receiving (302), from an agent (202), a translation checkout request (320) comprising an effective address (EA) and an effective address to real address table (ERAT) index, wherein the agent comprises an ERAT, and wherein the EA index identifies an entry in the ERAT within the agent (202); translating (304) the EA to a real address (RA) using an entry in a translation lookaside buffer (TLB) within the MMU (206), wherein the TLB within the MMU (206) comprises an RA for each EA in the ERAT within the agent (202); flagging (306) the entry in the TLB as in use by the agent (202), wherein the entry in the TLB comprises a TLB index, and wherein the TLB index identifies the entry in the TLB; storing (308) the EA index and the TLB index in an in-use scoreboard (IUSB), wherein the IUSB maps TLB indexes identifying entries in the TLB within the MMU (206) to ERAT indexes identifying entries in the ERAT within the agent (202); and sending (310), to the agent (202), a translation checkout response (322) comprising the RA.

The method of FIG. 5 differs from the method of FIG. 3, however, in that the method of FIG. 5 further includes determining (502), by the MMU (206), that the entry in the TLB will be removed. Determining (502), by the MMU (206), that the entry in the TLB will be removed may be carried out by the MMU (206) determining that a snoop invalidate process has indicated that a TLB entry is to be invalidated and removed.

The method of FIG. 5 also includes sending (504), to the agent (202), a raise barrier request instructing the agent (202) to quiesce an interface between the agent (202) and the MMU (206). Sending (504), to the agent (202), a raise barrier request instructing the agent (202) to quiesce an interface between the agent (202) and the MMU (206) may be carried out by the MMU (206) in response to detecting a snoop invalidate hit or a castout of a TLB (or intermediary translation lookaside buffer) entry that includes an agent flag for the agent (202). Because the TLB entry is to be removed, each ERAT entry on each agent that uses the translation stored in that TLB entry must also be invalidated or removed. Invalidation management is handled and completed by the MMU (206), thus freeing the agents from the resource overhead required to manage invalidations while allowing the agents to utilize the efficiencies of a local ERAT.

In order to begin the invalidation process of the related ERAT entries, the MMU (206) first must instruct the agents with the related ERAT entries to quiesce the interface between the MMU (206) and the agent (202). Instructing the agent to quiesce the interface between the agent and the MMU may include instructing the agent to halt translation checkout requests. Instructing the agent to quiesce the interface may also include instructing the agent (202) to send, to the MMU (206), a raise barrier response after all pending translation operations have completed. In response to the raise barrier request, the agent (202) halts new translation checkout requests (320) and waits for each currently pending translation checkout request (320) to receive a response. Once the interface has been quiesced, the agent (202) sends the MMU (206) a raise barrier response indicated that the translation checkout requests have been halted and all pending translation checkout requests have received responses.

The method of FIG. 5 also includes sending (506), to the agent (202), an invalidation request comprising the ERAT index. Sending (506), to the agent (202), an invalidation request comprising the ERAT index may be carried out by determining the ERAT index for the invalidated TLB entry by inspecting the IUSB entry for the TLB entry using the TLB index. Once the ERAT index corresponding to the TLB index is determined, the invalidation request is generated and the MMU (206) sends the invalidation request with the ERAT index to the agent (202). In response, the agent (202) completes all pending read and write operations that use the ERAT entry identified by the received ERAT index. Multiple invalidation requests for different ERAT indexes may be sent to an agent (202) during the raise barrier period.

The method of FIG. 5 also includes receiving (508), from the agent (202), an invalidation response indicating that pending translations targeting the entry in the ERAT identified by the ERAT index have completed. Receiving (508), from the agent (202), an invalidation response indicating that pending translations targeting the entry in the ERAT identified by the ERAT index have completed may be carried out by the agent (202) tracking each pending translation targeting the translation at the ERAT entry identified by the ERAT index. Once each pending translation has completed, the invalidation response is generated by the agent (202) and sent to the MMU (206)

The method of FIG. 5 also includes removing (510) the entry in the TLB from the TLB. Removing (510) the entry in the TLB from the TLB may be carried out by the MMU (206) in response to receiving the invalidation response from the agent (202). The TLB entry targeted by the snoop invalidate or castout operation may then be invalidated or removed from the TLB.

The method of FIG. 5 also includes removing (512) an entry in the IUSB mapping the ERAT index to the TLB index. Removing (512) an entry in the IUSB mapping the ERAT index to the TLB index may be carried out by the MMU (206) in response to receiving the invalidation response from the agent (202). The MMU (206) may then search the IUSB for the IUSB entry for the ERAT index and invalidate or remove the IUSB entry for the ERAT index.

The method of FIG. 5 also includes sending (514), to the agent (202), a lower barrier request instructing the agent (202) to resume sending translation checkout requests to the MMU. Sending (514), to the agent (202), a lower barrier request instructing the agent (202) to resume sending translation checkout requests to the MMU may be carried out by the MMU (206) determining that the TLB and IUSB entries for the agent (202) have been removed and the barrier is no longer necessary. The agent (202) may, in response to receiving the lower barrier request, send a lower barrier response to the MMU (206) and resume sending translation checkout requests to the MMU (206).

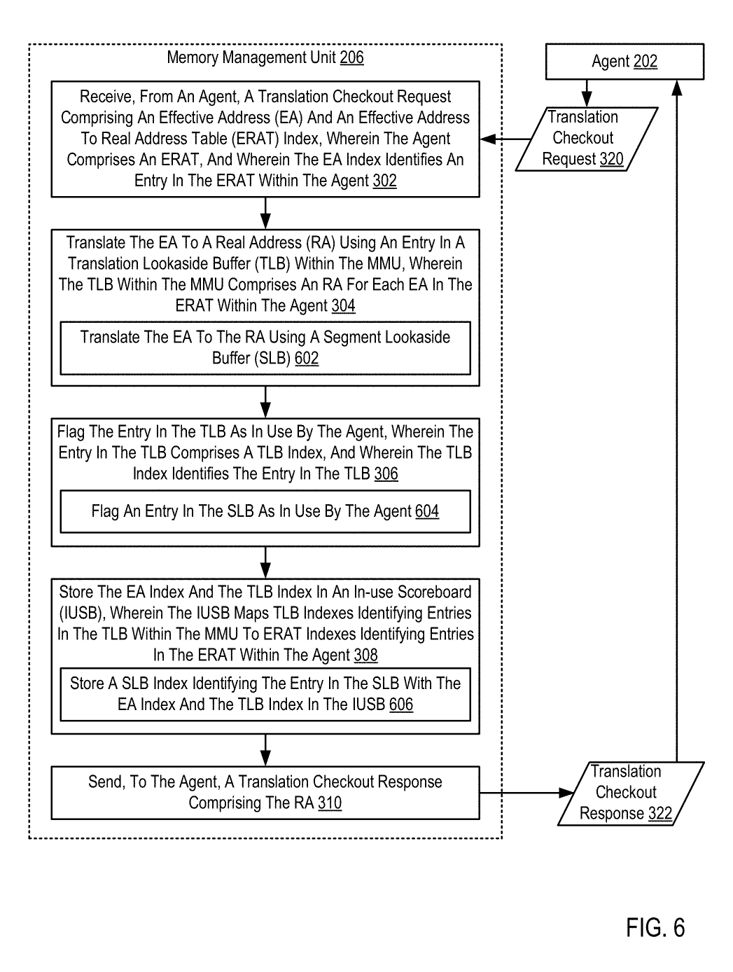

For further explanation, FIG. 6 sets forth a flow chart illustrating a further exemplary method for maintaining agent inclusivity within a distributed MMU according to embodiments of the present invention that includes receiving (302), from an agent (202), a translation checkout request (320) comprising an effective address (EA) and an effective address to real address table (ERAT) index, wherein the agent comprises an ERAT, and wherein the EA index identifies an entry in the ERAT within the agent (202); translating (304) the EA to a real address (RA) using an entry in a translation lookaside buffer (TLB) within the MMU (206), wherein the TLB within the MMU (206) comprises an RA for each EA in the ERAT within the agent (202); flagging (306) the entry in the TLB as in use by the agent (202), wherein the entry in the TLB comprises a TLB index, and wherein the TLB index identifies the entry in the TLB; storing (308) the EA index and the TLB index in an in-use scoreboard (IUSB), wherein the IUSB maps TLB indexes identifying entries in the TLB within the MMU (206) to ERAT indexes identifying entries in the ERAT within the agent (202); and sending (310), to the agent (202), a translation checkout response (322) comprising the RA.

The method of FIG. 6 differs from the method of FIG. 3, however, in that translating (304) the EA to a real address (RA) using an entry in a translation lookaside buffer (TLB) within the MMU (206), wherein the TLB within the MMU (206) comprises an RA for each EA in the ERAT within the agent (202) includes translating (602) the EA to the RA using a segment lookaside buffer (SLB). Translating (602) the EA to the RA using a segment lookaside buffer (SLB) may be carried out by using a portion of the EA to obtain a virtual segment ID from the SLB, and using the virtual segment ID and the EA to generate a virtual address. The virtual address may then be used to obtain a RA from the TLB.

The method of FIG. 6 also differs from the method of FIG. 3 in that flagging (306) the entry in the TLB as in use by the agent (202), wherein the entry in the TLB comprises a TLB index, and wherein the TLB index identifies the entry in the TLB includes flagging (604) an entry in the SLB as in use by the agent (202). Flagging (604) an entry in the SLB as in use by the agent (202) may be carried out by setting the agent flag for the SLB entry to high or up. Each SLB entry may have an agent flag for each agent for which agent inclusivity is maintained. The agent flag may be stored in the SLB entry or in a separate data structure with entries corresponding to the SLB entries.

The method of FIG. 6 also differs from the method of FIG. 3 in that storing (308) the EA index and the TLB index in an in-use scoreboard (IUSB), wherein the IUSB maps TLB indexes identifying entries in the TLB within the MMU (206) to ERAT indexes identifying entries in the ERAT within the agent (202) includes storing (606) a SLB index identifying the entry in the SLB with the EA index and the TLB index in the IUSB. Storing (606) a SLB index identifying the entry in the SLB with the EA index and the TLB index in the IUSB may be carried out by generating the IUSB entry with the ERAT index, SLB index, and TLB index as each index is determined. Once the IUSB entry is complete, the IUSB entry is added to the IUSB.

In view of the explanations set forth above, readers will recognize that the benefits of maintaining agent inclusivity within a distributed MMU according to embodiments of the present invention include:
Improving the operation of a multi-agent processor by installing an ERAT into each agent, increasing agent memory efficiency.
Improving the operation of a multi-agent processor by offloading invalidation management to a central MMU, increasing processor efficiency.

Exemplary embodiments of the present invention are described largely in the context of a fully functional computer system for maintaining agent inclusivity within a distributed MMU. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method of maintaining agent inclusivity within a distributed memory management unit (MMU), the method comprising:
receiving, from an agent, a translation checkout request comprising an effective address (EA) and an effective address to real address table (ERAT) index, wherein the agent comprises an ERAT, and wherein the EA index identifies an entry in the ERAT within the agent;
translating the EA to a real address (RA) using an entry in a translation lookaside buffer (TLB) within the MMU, wherein the TLB within the MMU comprises an RA for each EA in the ERAT within the agent;
flagging the entry in the TLB as in use by the agent, wherein the entry in the TLB comprises a TLB index, and wherein the TLB index identifies the entry in the TLB;
storing the EA index and the TLB index in an in-use scoreboard (IUSB), wherein the IUSB maps TLB indexes identifying entries in the TLB within the MMU to ERAT indexes identifying entries in the ERAT within the agent; and
sending, to the agent, a translation checkout response comprising the RA.

2. The method of claim 1, further comprising:
receiving, from the agent, a translation checkin request comprising the ERAT index;
removing, from the IUSB, an entry in the IUSB mapping the ERAT index to the TLB index;
removing a flag from the entry in the TLB indicating the entry in the TLB is in use by the agent; and
sending, to the agent, a translation checkin response instructing the agent to remove the ERAT entry identified by the ERAT index.

3. The method of claim 1, further comprising:
determining, by the MMU, that the entry in the TLB will be removed;
sending, to the agent, a raise barrier request instructing the agent to quiesce an interface between the agent and the MMU;
sending, to the agent, an invalidation request comprising the ERAT index;
receiving, from the agent, an invalidation response indicating that pending translations targeting the entry in the ERAT identified by the ERAT index have completed;
removing an entry in the IUSB mapping the ERAT index to the TLB index;
removing the entry in the TLB from the TLB; and
sending, to the agent, a lower barrier request instructing the agent to resume sending translation checkout requests to the MMU.

4. The method of claim 3, wherein instructing the agent to quiesce the interface between the agent and the MMU comprises instructing the agent to halt translation checkout requests and send, to the MMU, a raise barrier response after all pending translation operations have completed.

5. The method of claim 1, wherein the IUSB maps, to TLB indexes, ERAT indexes identifying entries in a plurality of ERATs of a plurality of agents.

6. The method of claim 1, wherein translating the EA to the RA further uses a segment lookaside buffer (SLB), wherein flagging the entry in the TLB as in use by the agent further comprises flagging an entry in the SLB as in use by the agent, and wherein storing the EA index and the TLB index in the IUSB comprises storing a SLB index identifying the entry in the SLB with the EA index and the TLB index in the IUSB.

7. The method of claim 1, wherein the translation checkout response further comprises a page size and an indication of whether the agent has permission to write data to a memory location identified by the RA.

8-20. (canceled)
